(19) United States
(12) Patent Application Publication
(10) Pub. No.: US 2019/0327999 A1
(43) Pub. Date: Oct. 31, 2019

(54) Black Tea Extract and Preparation Method Therefor

(71) Applicant: SHANGHAI KE BAO BIOTECH CO., LTD, Shanghai (CN)

(72) Inventors: Jian Zhao, Shanghai (CN); Chenda Zhu, Shanghai (CN); Beiwen Jin, Shanghai (CN)

(21) Appl. No.: 16/477,542

(22) PCT Filed: Jul. 19, 2017
(86) PCT No.: PCT/CN2017/093465

§ 371 Date: Jul. 12, 2019

(30) Foreign Application Priority Data
Jan. 13, 2017 (CN) 201710026463.9

(51) Int. Cl. A23F 3/18; A23L 33/105; A23F 3/22; A23F 3/10

(52) U.S. Cl. CPC A23F 3/18; A23F 3/10; A23F 3/22; A23L 33/105

(57) ABSTRACT

A black tea extract, comprising 20-30% parts by weight of theaflavin and 40-50% parts by weight of catechin. The theaflavin and the catechin in the black tea extract can be obtained by conventional high-concentration tea polyphenol extraction in the art, and can also be commercially available theaflavin and catechin in the art.

The present invention claims priority to Chinese Patent Application CN. 201710026463.9, filed on Jan. 13, 2017, the contents of which are incorporated herein by reference in their entireties.

### FIELD OF INVENTION

The present invention relates to a black tea extract and a preparation method therefor.

### PRIOR ARTS

Obesity has always been the focus of attention in recent years. With the rapid increase in the number of obese people in the world, people's health has been greatly threatened. Obesity can cause many serious diseases, such as diabetes, fatty liver and cardiovascular disease. From the beginning of the last century, researchers have been constantly committed to the development of weight-loss drugs. The first batch of weight-loss drugs were mainly used in people's central nervous system. By suppressing people's appetite and controlling the diet, losing weight has been realized. One of the most popular ingredients is sibutramine. However, as the number of users increases, more serious side effects are observed in clinic. These neurological inhibitors are gradually listed as illegal drugs in various countries in the world.

Later, people turned their attention to the absorption of fat. Orlistat is the most successful and the only chemical drug approved by the US FDA for weight loss so far. Orlistat can form a covalent compound with the active site of pancreatic lipase in the intestine, thereby inhibiting the activity of pancreatic lipase. Although orlistat does not enter the human body's blood circulation, and is regarded as the safest weight-loss drug, but users still experienced some intolerable side effects.

Fat absorption is accomplished by a series of complex but very fine and rigorous biochemical reaction steps. By performing an interference attack on any step in the chain of reactions, inhibition of fat absorption can be achieved. After the body ingests fat, the large fat particles are dispersed into small particles in the stomach. After entering the duodenum, small fat particles are emulsified to form a micro-micelle structure under the action of bile salts. Due to even dispersion in the digestive juice, contact area with pancreatic lipase in digestive juice is increased, thereby increasing the efficiency of fat hydrolysis, so that the fat in the food can be effectively absorbed by the intestine. The active constituents of the black tea extract, theaflavins and catechins, can effectively inhibit the formation of fat micro-micelles, reduce the decomposition and absorption efficiency of fat, and make more fat directly excreted from the intestinal tract instead of effective absorption, thereby achieve the effect of inhibiting fat absorption. Although there are direct use of black tea extract as an active substance of weight-loss drugs on the market at present, the corresponding side effects will be produced. However, the effect of drinking black tea directly on weight loss is not obvious, and it is difficult to meet expectations of consumers. The development of new weight-loss products remains a difficult and urgently anticipated task.

### CONTENT OF THE PRESENT INVENTION

The technical problem to be solved in the present invention is to overcome the defects that the existing weight-loss drugs or active substances of weight-loss drugs have many side effects and poor effects during use, thus a black tea extract and a preparation method therefor are provided. The black tea extract provided by the present invention can effectively inhibit the absorption of fat, thereby achieving the effect of losing weight and greatly reducing the adverse side effects.

The inventors have found a special proportion of black tea extract after extensive experiments and research. By controlling the composition ratio of each ingredient in the black tea extract, it may have a good effect on inhibiting fat absorption, and significantly reduce adverse effects of the black tea extract to gastric stimulation.

The present invention solves the above-mentioned technical problems through the following technical solutions:

The technical solution of the present invention is to provide a black tea extract, comprising, by mass fraction, the following ingredients: 20-30% of theaflavins and 40-50% of catechins.

In the present invention, the theaflavins and the catechins in the black tea extract may be obtained by extracting from tea polyphenols with high concentration conventional in the art, or may be commercially available theaflavins or catechins in the art.

Preferably, the tea polyphenols with high concentration is a tea polyphenol with a tea polyphenol content of 80-90%. In the present invention, the tea polyphenols with high concentration are generally obtained by the conventional tea polyphenols extraction process using green tea as raw material.

Preferably, the commercially available theaflavins or catechins may be commercially available from NASHAI Corporation of the United States.

In the present invention, the theaflavins refer to one of the tea polyphenols extracts, and are composed of the following four substances: TF1 (monomeric theaflavin), TF2A (theaflavin-3-monogallate), TF2B (theaflavin-3′-monogallate), TF3 (theaflavin-3,3′-bis gallate).

Wherein, the content of TF1, TF2A, TF2B, and TF3 is conventional in the art, preferably, the content of TF1, TF2A, TF2B, and TF3 in mass fraction ratio is: TF1:(TF2A+TF2B):TF3=(4.8-7.1):(8.8-11.4):(4.3-5.2).

In the present invention, the catechins refer to one of the tea polyphenols extracts, and comprise the following substances: ECG (epicatechin gallate), EGCG (epigallocatechin gallate), EGC (Epigallocatechin), C (monomeric catechin).

Wherein, the content of ECG, EGCG, EGC, and C is conventional in the art, preferably, the content of ECG, EGCG, EGC, and C in mass fraction ratio is: ECG:EGCG:EGC:C=(6.0-12.6):(24.6-29.8):(2.4-5.6):(0.4-0.8).

Preferably, according to the present invention, the mass fraction of the theaflavins in the black tea extract is 23.1, and the mass fraction of the catechins is 46.5; or, the mass fraction of the theaflavins is 25, and the mass fraction of the catechins is 45.

The above-mentioned black tea extract of the present invention can be obtained by uniformly mixing the ingredients according to conventional methods in the art. Another technical solution of the present invention is to provide a preparation method for a black tea extract, comprising the following steps:
(1) Pulverizing fresh tea leaves;
(2) Mixing evenly the tea polyphenols with the fresh tea leaves after pulverizing, the mass ratio of the tea polyphenols to the fresh tea leaves after pulverizing is (10-20):1;
(3) Fermenting the evenly mixed raw materials in step (2) at a temperature range of 25-27° C., until the mass percentage of the theaflavins in the raw materials falling within the range of 20-30% to deliver a black tea extract.

In the present invention, the fresh tea leaves described in step (1) are conventional names in the art, which refers to the tea leaves without a series of common green tea production processes such as drying, fixing and the like.

In the present invention, the pulverization treatment described in step (1) is a common operation in the art, aiming to break the cell walls of fresh tea leaves to prepare enzymes. Preferably, the pulverization treatment is carried out by pulverizing the fresh tea leaves with a pulverizer and passing through a sieve of 80 mesh.

In the present invention, the fermentation treatment in step (3) is preferably carried out for 6.5 to 7.5 hours. In the fermentation process of step (2), in order to determine that if the mass percentage of the theaflavins in the raw materials is 20%-30%, after fermenting for 6.5 h, the ingredient content is monitored in real time by HPLC every 15 min. When the mass percentage of the theaflavins in the black tea extract in the present invention is in the range of 20%-30%, the fermentation was terminated.

In the present invention, tea polyphenol is preferably further added after the fermentation described in step (3) to adjust the content of each ingredient in the black tea extract.

In the present invention, after the black tea extract is obtained in step (3), the following operation is preferably carried out: the black tea extract is extracted, concentrated, and dried to obtain a black tea extract powder.

Wherein, the extraction is a common operation in the art, preferably extraction using water.

Wherein, the concentration is the concentration under reduced pressure commonly used in the art.

Wherein, the drying is a common operation in the art, preferably, the drying is spray drying.

In the present invention, the black tea extract obtained by the preparation method has a mass percentage of 20%-30% of theaflavins and 40%-50% of catechins, and further includes other fermenting substances, mainly theabrownins and thearubigins. The mass percentage of the other fermenting substances is 20-40%.

The present invention also provides a black tea extract prepared by the above preparation method.

Based on the common knowledge in the art, the above various preferred conditions can be arbitrarily combined to obtain preferred embodiments of the present invention.

The reagents and starting materials used in the present invention are commercially available.

Advantageous effects of the present invention are that: the black tea extract provided by the present invention can not only effectively inhibit the absorption of fat, achieving the purpose of weight loss, but also does not produce major side effects; meanwhile, the preparation method for the black tea extract is simple and feasible and has great market value.

### DETAILED DESCRIPTION OF THE PREFERRED EMBODIMENT

The theaflavins 40 and the theaflavins 60 mentioned in the following comparative embodiments were purchased from NASHAI Corporation of the United States.

The catechins mentioned in the following comparative embodiments were purchased from NASHAI Corporation of the United States.

In the following embodiments, comparative embodiments and effect embodiments, the content of each monomer of theaflavins was determined by an external standard method, TF1 (Theaflavin), TF2A+TF2B (Mixture of Theaflavin 3-gallate and Theaflavin 3′-gallate), TF3 (Theaflavin 3,3′-digallate), the three set of monomer standards were purchased from Sigma.

In the following embodiments, comparative embodiments and effect embodiments, the content of each monomer of catechins was determined by an external standard method, C and EGCG standards were purchased from Sigma, and the remaining monomers were determined as a function of the conversion coefficient to obtain a standard curve.

In the following embodiments and comparative embodiments, HPLC detection conditions were as following: column: ODS (C18); mobile phase: acetonitrile and 0.1% phosphoric acid solution; column temperature: 35° C.; flow rate: 2 mL/min; detection wavelength: 280 nm; injection amount: 10 μL.

### Embodiment 1

Provided in the embodiment were a black tea extract and a preparation method therefor. The black tea extract of the embodiment contained 23.1% of theaflavins, 46.5% of catechins, and 30.4% of other black tea fermenting substances (main ingredients including theabrownins, thearubigins, tannic acid, and gallic acid).

Wherein, the contents of TF1, TF2A and TF2B, and TF3 in theaflavins were 6.9%, 11.1%, and 5.1%, respectively.

Wherein, the contents of C, EGC, EGCG and ECG in catechins were 0.6%, 3.9%, 27.2%, and 8.0%, respectively.

The above percentage was the mass percentage of each ingredient to the black tea extract.

The black tea extract of the embodiment was obtained by the following method:

100 g fresh tea leaves was pulverized with a pulverizer and passed through an 80-mesh sieve; 1000 g of tea polyphenols was charged into a fermentation tank, the fresh tea leaves after pulverization was then added into, uniformly mixed, after fermenting at a temperature of 26° C. for 6.5 hours, the ingredient content was monitored in real time by HPLC every 15 min. When the mass percentage of theaflavins was determined to be 23.1%, the fermentation was terminated, and the black tea extract was obtained when the fermenting time was 7 hours in total. The black tea extract was extracted with ten times the amount of water, and the two extracts were combined, concentrated under reduced pressure, and dried to obtain a black tea extract powder.

### Embodiment 2

Provided in the embodiment were a black tea extract and a preparation method therefor. The black tea extract of the embodiment contained 35.7% of theaflavins and 64.3% of catechins.

Wherein, the contents of TF1, TF2A and TF2B, and TF3 in theaflavins were 10%, 17.1%, and 8.6%, respectively.

Wherein, the contents of C, EGC, EGCG and ECG in catechins were 0.8%, 6.5%, 40.7%, 16.3%, respectively.

The above percentage was the mass percentage of each ingredient to the black tea extract.

The black tea extract of the embodiment was obtained by the following method:

100 g of commercially available theaflavins 40, 276 g of commercially available theaflavins 60 and 200 g of tea polyphenol were mixed, and the content of each ingredient was monitored by HPLC in real time. When the content of theaflavins was 35.7%, the preparation was terminated.

### Comparative Embodiment 1

Provided in the embodiment were a black tea extract and a preparation method therefor. The black tea extract of the embodiment contained 5.8% of theaflavins, 73.2% of catechins, and 21.0% of other black tea fermenting substances (main ingredients including theabrownins, thearubigins, tannic acid, and gallic acid).

Wherein, the contents of TF1, TF2A and TF2B, and TF3 in theaflavins were 1.6%, 2.9%, and 1.3%, respectively.

Wherein, the contents of C, EGC, EGCG and ECG in catechins were 1.1%, 6.2%, 43.1%, 12.6%, respectively.

The above percentage was the mass percentage of each ingredient to the black tea extract.

The black tea extract of the comparative embodiment was obtained by the following method:

100 g of Jiangxi Wuyuan green tea was fermented for 7 hours by simulating black tea production process. The black tea extract was extracted with ten times the amount of water, and the two extracts were combined, concentrated under reduced pressure, and dried, the content of each ingredient was determined by HPLC, wherein the mass percentage of theaflavins was 5.8%.

### Comparative Embodiment 2

Provided in the comparative embodiment were a black tea extract and a preparation method therefor. The black tea extract of the embodiment contains 42.8% of theaflavins, 26.8% of catechins, and 30.4% of other black tea fermenting substances (main ingredients including theabrownins, thearubigins, tannic acid, and gallic acid) (similar to the composition of commercially available theaflavin 40).

Wherein, the contents of TF1, TF2A and TF2B, and TF3 in theaflavins were 12.9%, 21.1%, and 8.8%, respectively.

Wherein, the contents of C, EGC, EGCG and ECG in catechins were 0.4%, 2.4%, 15.6%, 4.8%, respectively.

The above percentage was the mass percentage of each ingredient to the black tea extract.

The black tea extract of the comparative embodiment was obtained by the following method:

The black tea extract obtained from Example 1 was used as raw material, and extracted with ethyl acetate and sodium bicarbonate solution by Roberts method to obtain high purity theaflavin. HPLC was used to determine the content of theaflavin in the extract, and then commercially available catechins was added, to adjust mass percentage of theaflavins in the extract to 42.8%.

### Comparative Embodiment 3

Provided in the comparative embodiment were a black tea extract and a preparation method therefor. The black tea extract of the embodiment contains 63.7% of theaflavins, 10.5% of catechins, and 25.8% of other black tea fermenting substances (main ingredients including theabrownins, thearubigins, tannic acid, and gallic acid) (similar to the composition of commercially available theaflavin 60).

Wherein, the contents of TF1, TF2A and TF2B, and TF3 in theaflavins were 19.4%, 30.7%, and 13.6%, respectively.

Wherein, the contents of C, EGC, EGCG and ECG in catechins is 0.1%, 0.9%, 6.3%, 1.7%, respectively.

The above percentage was the mass percentage of each ingredient to the black tea extract.

The black tea extract of the comparative embodiment was obtained by the following method:

The black tea extract obtained from Example 1 was used as raw material, and extracted with ethyl acetate and sodium bicarbonate solution by using Roberts method to obtain theaflavins with high purity. The content of theaflavins in the extract was determined by HPLC, and then commercially available catechins was added, to adjust mass percentage of theaflavins therein to be 63.7%.

### Effect Example 1

42 male C57BL mice, three weeks old, were divided into 7 groups on average, including high fat group (HF), low fat group (LF) and 5 groups of tea extract group (TE1-5), with 6 rats in each group. Each two were housed separately in a metabolic cage. In the first four weeks (Day1-Day30), all mice in the six groups were fed with high-fat diet (45% calories from fat) and ate freely. From the fifth week (Day31-Day52), the fodder of the low fat group was replaced with low fat diet (10% calories from fat), and the fodders of the tea extract groups were mixed with 0.5% of black tea extracts with different contents of theaflavins into the high fat diet, wherein the TE1 group used the black tea extract of embodiment 1; the TE2 group used the black tea extract of embodiment 2; the TE3 group used the black tea extract of comparative embodiment 1; the TE4 group used the black tea extract of comparative embodiment 2; and the TE5 group used the black tea extract of comparative embodiment 3. The animals were kept feeding for 4 weeks, and the body weight, food intake and fecal fat content of each group were recorded. All the feeds were purchased from the Teklad feeds of Envigo, and the contents of the black tea extracts of each tea extract group were shown in Table 1 and Table 2

TABLE 1
Contents of theaflavins and ingredients therein in tea extracts (%)

| | Theaflavins | TF1 | TF2A + TF2B | TF3 |
|---|---|---|---|---|
| TE1 | 23.1 | 6.9 | 11.1 | 5.1 |
| TE2 | 35.7 | 10 | 17.1 | 8.6 |
| TE3 | 5.8 | 1.6 | 2.9 | 1.3 |
| TE4 | 42.8 | 12.9 | 21.1 | 8.8 |
| TE5 | 63.7 | 19.4 | 30.7 | 13.6 |

TABLE 2
Contents of catechins and ingredients therein in tea extracts (%)

| | Catechins | ECG | EGCG | EGC | C |
|---|---|---|---|---|---|
| TE1 | 46.5 | 8.0 | 27.2 | 3.9 | 0.6 |
| TE2 | 64.3 | 16.3 | 40.7 | 6.5 | 0.8 |
| TE3 | 73.2 | 12.6 | 43.1 | 6.2 | 1.1 |
| TE4 | 26.8 | 4.8 | 15.6 | 2.4 | 0.4 |
| TE5 | 10.5 | 1.7 | 6.3 | 0.9 | 0.1 |

After the above mice were fed for 52 days, the data records of each group are shown in Table 3.

TABLE 3
Average daily feed consumption per two mice (g/day)

| | Day 32 | Day 36 | Day 40 | Day 44 | Day 48 | Day 52 |
|---|---|---|---|---|---|---|
| HF | 6.1 ± 0.8 | 6.6 ± 0.6 | 6.4 ± 0.4 | 6.2 ± 0.2 | 6.1 ± 0.2 | 6.1 ± 0.1 |
| LF | 4.9 ± 0.3 | 5.8 ± 0.4 | 5.9 ± 0.3 | 6.2 ± 0.2 | 5.9 ± 0.2 | 6.2 ± 0.1 |
| TE1 | 7.9 ± 0.6 | 6.5 ± 0.3 | 6.4 ± 0.4 | 6.3 ± 0.1 | 6.1 ± 0.2 | 6.1 ± 0.1 |
| TE2 | 7.8 ± 0.5 | 6.6 ± 0.2 | 6.3 ± 0.4 | 6.3 ± 0.1 | 6.0 ± 0.3 | 6.1 ± 0.1 |
| TE3 | 6.5 ± 0.4 | 6.5 ± 0.4 | 6.4 ± 0.3 | 6.2 ± 0.2 | 6.1 ± 0.1 | 6.2 ± 0.1 |
| TE4 | 7.1 ± 0.7 | 6.4 ± 0.4 | 6.5 ± 0.3 | 6.3 ± 0.2 | 6.1 ± 0.2 | 6.1 ± 0.1 |
| TE5 | 2.2 ± 0.1 | 4.7 ± 0.5 | 5.3 ± 0.3 | 5.2 ± 0.1 | 5.4 ± 0.3 | 5.2 ± 0.1 |

After changing the diet on the 32nd day, the food intake by mice of the TE5 group showed a significant decrease, and the mice in this group showed some signs of restlessness, such as shredding the food, arching back and the like. Two mice in the TE4 group appeared as similar mild situation, while none in the other groups were appeared as similar situation. Probably because the high content of theaflavins stimulated the gastric mucosa of mice, causing discomfort in the stomach. After gradual adaptation, the food intake of mice in group TE5 increased to a certain extent.

The fat content in the feces of mice was measured, and the data were shown in table 4:

TABLE 4
Average fat content in feces (%)

| | Day 32 | Day 36 | Day 40 | Day 44 | Day 48 | Day 52 |
|---|---|---|---|---|---|---|
| HF | 0.07 ± 0.01 | 0.06 ± 0.01 | 0.09 ± 0.01 | 0.05 ± 0.01 | 0.06 ± 0.01 | 0.05 ± 0.01 |
| LF | 0.06 ± 0.01 | 0.04 ± 0.01 | 0.04 ± 0.01 | 0.03 ± 0.01 | 0.04 ± 0.01 | 0.04 ± 0.01 |
| TE1 | 0.13 ± 0.03 | 0.10 ± 0.04 | 0.12 ± 0.02 | 0.11 ± 0.03 | 0.11 ± 0.03 | 0.13 ± 0.02 |
| TE2 | 0.13 ± 0.02 | 0.11 ± 0.04 | 0.13 ± 0.02 | 0.11 ± 0.02 | 0.12 ± 0.02 | 0.13 ± 0.01 |
| TE3 | 0.09 ± 0.01 | 0.07 ± 0.01 | 0.10 ± 0.01 | 0.07 ± 0.02 | 0.08 ± 0.01 | 0.07 ± 0.01 |
| TE4 | 0.14 ± 0.03 | 0.11 ± 0.03 | 0.12 ± 0.01 | 0.11 ± 0.01 | 0.11 ± 0.02 | 0.13 ± 0.02 |
| TE5 | 0.16 ± 0.04 | 0.11 ± 0.02 | 0.12 ± 0.02 | 0.09 ± 0.01 | 0.12 ± 0.01 | 0.11 ± 0.02 |

The results of data analysis showed that the fat contents in feces of the tea extract groups were significantly higher than that of the high fat group and low fat groups. In the tea extract groups, the TE3 group was slightly lower than the other three groups, and there was no statistical difference between the other three groups. It can be seen that theaflavins are not a single factor affecting fecal fat excretion, and there is a certain synergistic relationship between theaflavins and catechins.

Combined with the data of food intake, the behavior of feeding mice and fecal fat excretion, it can be seen that the proportion of each ingredient in the tea extract provided by the present invention is the best proportion, which not only achieved the best effect, but also greatly reduced the side effects brought by theaflavins.

It is to be understood that the foregoing description of preferred embodiments is intended to be purely illustrative of the principles of the present invention, rather than exhaustive thereof, and that changes and variations will be apparent to those skilled in the art without departing from the principles and essence of the present invention. Accordingly, the scope of protection of the present invention is limited by the appended claims.

1. A black tea extract, wherein, by mass fraction, comprising the following ingredients: 20-30% of theaflavins and 40-50% of catechins.

2. The black tea extract according to claim 1, wherein, the theaflavins are composed of TF1, TF2A, TF2B, and TF3, and the content of TF1, TF2A, TF2B, and TF3 in mass fraction ratio is: TF1:(TF2A+TF2B):TF3=(4.8-7.1):(8.8-11.4):(4.3-5.2).

3. The black tea extract according to claim 1, wherein, the catechins contain ECG, EGCG, EGC, and C, and the content of ECG, EGCG, EGC, and C in mass fraction ratio is: ECG:EGCG:EGC:C=(6.0-12.6):(24.6-29.8):(2.4-5.6):(0.4-0.8).

4. The black tea extract according to claim 1, wherein, the mass fraction of the theaflavins in the black tea extract is 23.1, and the mass fraction of the catechins is 46.5; or the mass fraction of the theaflavins is 25, and the mass fraction of the catechins is 45.

5. A preparation method for a black tea extract, wherein, comprising the following steps:
(1) Pulverizing fresh tea leaves;
(2) Mixing evenly the tea polyphenols with the fresh tea leaves after pulverizing, the mass ratio of the tea polyphenols to the fresh tea leaves after pulverizing is (10-20):1;
(3) Fermenting the evenly mixed raw materials in step (2) at a temperature range of 25-27° C., until the mass fraction of the theaflavins in the raw materials falling within the range of 20-30% to deliver a black tea extract.

6. The preparation method according to claim 5, wherein, the pulverization treatment in step (1) is carried out by pulverizing the fresh tea leaves with a pulverizer and passing through a sieve of 80 mesh.

7. The preparation method according to claim 5, wherein, the fermentation time in step (3) is 6.5 to 7.5 hours; and after the fermentation in step (3), tea polyphenol is further added to adjust the content of each ingredient in the black tea extract.

8. The preparation method according to claim 5, wherein, after the black tea extract is obtained in step (3), the black tea extract is extracted, concentrated, and dried to obtain a black tea extract powder.

9. The preparation method according to claim 8, wherein, the extraction is carried out with water;
or, the concentration is the concentration under reduced pressure;
or, the drying is spray drying.

10. A black tea extract prepared by the preparation method for a black tea extract according to claim 5.

11. The black tea extract according to claim 2, wherein, the catechins contain ECG, EGCG, EGC, and C, and the content of ECG, EGCG, EGC, and C in mass fraction ratio is: ECG:EGCG:EGC:C=(6.0-12.6):(24.6-29.8):(2.4-5.6):(0.4-0.8).

12. The black tea extract according to claim 2, wherein, the mass fraction of the theaflavins in the black tea extract is 23.1, and the mass fraction of the catechins is 46.5; or the mass fraction of the theaflavins is 25, and the mass fraction of the catechins is 45.

13. The black tea extract according to claim 3, wherein, the mass fraction of the theaflavins in the black tea extract is 23.1, and the mass fraction of the catechins is 46.5; or the mass fraction of the theaflavins is 25, and the mass fraction of the catechins is 45.

14. A black tea extract prepared by the preparation method for a black tea extract according to claim 6.

15. A black tea extract prepared by the preparation method for a black tea extract according to claim 7.

16. A black tea extract prepared by the preparation method for a black tea extract according to claim 8.

17. A black tea extract prepared by the preparation method for a black tea extract according to claim 9.
